(19) United States
(12) Patent Application Publication
(10) Pub. No.: US 2015/0040775 A1
(43) Pub. Date: Feb. 12, 2015

(54) STEAMER ASSEMBLY

(71) Applicant: LIFE & LIVING INTERNATIONAL LIMITED, Tainan (TW)

(72) Inventor: Jaw Chyi SHIEH, HK (CN)

(73) Assignee: LIFE & LIVING INTERNATIONAL LIMITED, Tainan (TW)

(21) Appl. No.: 13/960,789

(22) Filed: Aug. 6, 2013

(51) Int. Cl. A47J 27/04

(52) U.S. Cl. CPC A47J 27/04; A47J 2027/043
USPC 99/403

(57) ABSTRACT

A steamer assembly includes a base, a bowl, a steamer and a cover. The bowl is put in the base and has a flange which is rested on the top edge of the base. A space is defined in the bowl and a protrusion extends from the inner end of the space. A passage is defined through the protrusion. The steamer is mounted on the base or the bowl. The steamer is made by bamboo and has a lip extending from the underside thereof. A board made by red soil is put in the steamer and has multiple apertures. The cover is mounted to the top of the lapped base, bowl and steamer. Food is put in the bowl or the steamer and cooked by steam so as to keep the juice and flavor in the food.

### FIELD OF THE INVENTION

The present invention relates to a steamer assembly, and more particularly, to a steamer assembly having a base on which a bowl or a steamer is directly mounted, a cover is covered on the bowl or a steamer so as to keep the taste and flavor of the food.

### BACKGROUND OF THE INVENTION

One of the conventional ways to cook food is to steam the food by steam, Chinese buns, dim sums, and the like are steamed in a conventional steamer which provides steam to steam the food. The conventional way to steam food is to put a support board in a wok in which water is filled, the food is put on the board which has apertures. The water is heated and becomes steam which passes through the apertures of the board to steam the food on the board. However, the conventional way cannot maintain the juice generated from the good, and the juice flows through the apertures and is mixed with the water in the wok. The juice of the food relates the taste and flavor of the dish, in many situations, nutrition is in the juice.

Alternatively, another conventional steamer is made by bamboo strips and a piece of fabric is put in the steamer, and food is put on the piece of fabric in the steamer. The steamer is put on a board which is located in the base. Because the food is directly put on the piece of fabric so that the moisture is trapped between the bottom of the food and the piece of fabric, and this makes the bottom of the food to be easily torn apart and the food juice is lost.

The present invention intends to provide a steamer assembly which improves the shortcomings of the conventional steamers.

### SUMMARY OF THE INVENTION

The primary object of the present invention is to provide a steamer assembly which has better heat conducting feature and keep the nutrition and flavor in the food. The time required to steaming the food is shortened. The present invention relates to a steamer assembly and comprises a base made by fireproof ceramic, and a handle extends from outside of the base. A bowl is put in the base and made by stoneware. A flange extends outward from outside of the bowl. A space is defined in the bowl and a protrusion extends from the inner end of the space. A passage is defined through the protrusion. A steamer is mounted on the base or the bowl, the steamer is made by bamboo and has a lip extending from the underside thereof A board is put in the steamer and made by red soil. Multiple apertures are defined through the board. A cover is mounted to the base, the bowl or the steamer. The cover is made by fireproof ceramic and has multiple release holes defined therethrough. A lug extends centrally from the top of the cover.

The bowl is a round bowl and the top of the protrusion is in flush with the top edge of the bowl.

The steamer assembly keeps the juice and flavor of the food in the food, so that the food has better taste and the nutrition is maintained.

The steamer is used to receive the food therein and the time of steaming is shortened. The board made by red soil prevents the food from being attached on it so that when picking the food out from the steamer, the bottom of the food is not torn apart.

The steamer assembly can use the base only to cook food and the base has better heat conduction feature to save time of cooking.

The bowl and/or the steamer are optionally used with the base so as to steam different types of food.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the steamer assembly of the present invention;

FIG. 2 is a perspective view to show the steamer assembly of the present invention;

FIG. 3 is a cross sectional view to show the steamer assembly of the present invention, wherein the steamer and bowl are used with the base;

FIG. 4 is a cross sectional view to show the steamer assembly of the present invention, wherein the bowl is used with the base;

FIG. 5 is a cross sectional view to show the steamer assembly of the present invention, wherein the steamer is used with the base, and

FIG. 6 is a cross sectional view to show the steamer assembly of the present invention, wherein the base is individually used for cooking food.

### DETAILED DESCRIPTION OF THE PREFERRED EMBODIMENT

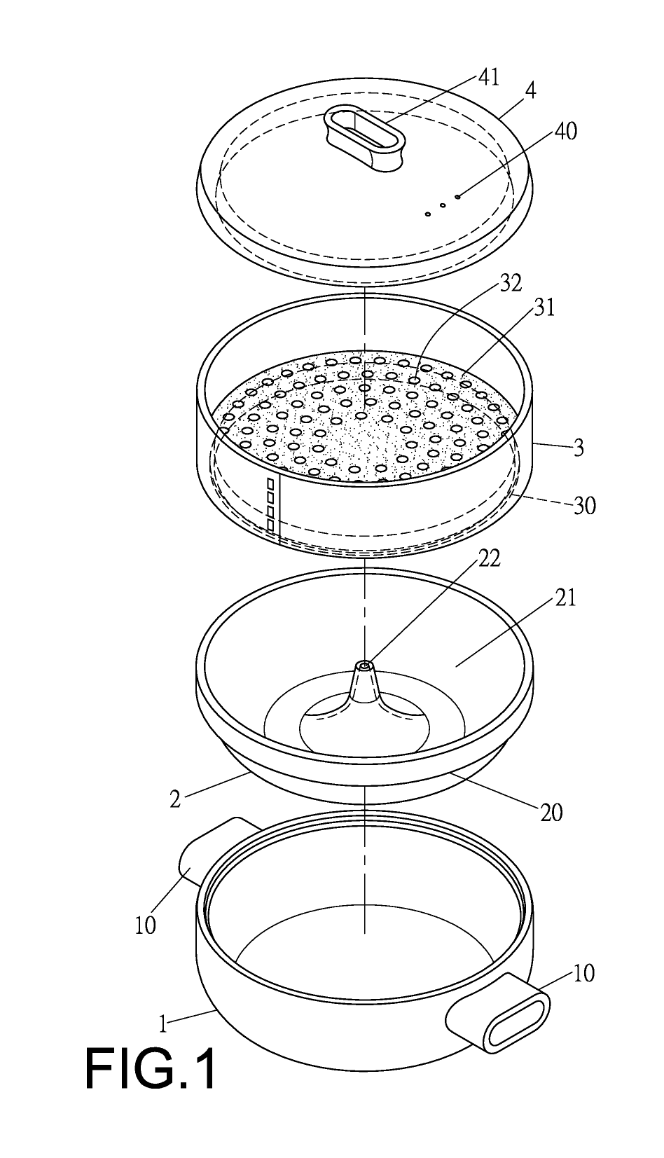

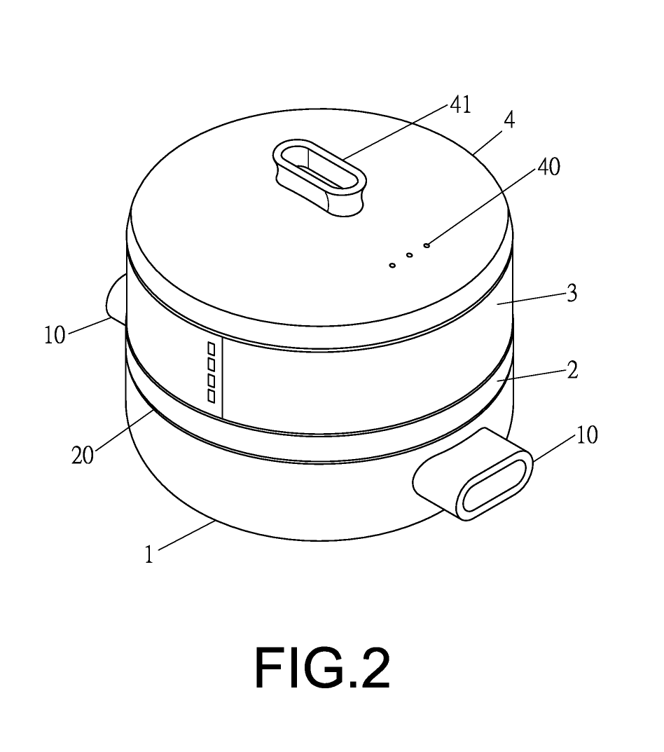

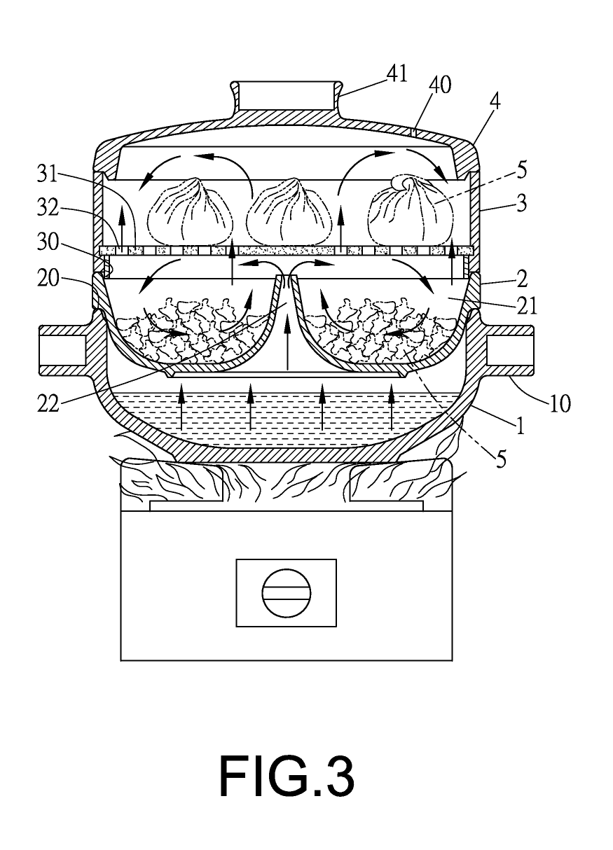

Referring to FIGS. 1 to 3, the steamer assembly of the present invention comprises a base 1 which is made by fireproof ceramic and two handles 10 extend from outside of the base 1. A bowl 2 is a round bowl and put in the base 1. The bowl 2 is made by stoneware and a flange 20 extends outward from outside of the bowl 2. A space 21 is defined in the bowl 2 and a protrusion extends from the center of the inner end of the space 21. A passage 22 is defined through the protrusion and the top opening of the passage 22 is slightly expanded outward. The top opening of the protrusion is in flush with the top edge of the bowl 2. A steamer 3 is mounted on the base 1 or the bowl 2. The steamer 3 is made by bamboo and has a lip 30 extending from the underside thereof. A board 31 is put in the steamer 3 and made by red soil. Multiple apertures 32 are defined through the board 31. A cover 4 is mounted to the base 1, the bowl 2 or the steamer 3. The cover 4 is made by fireproof ceramic and has multiple release holes 40 defined therethrough. A lug 41 extends centrally from the top of the cover 4.

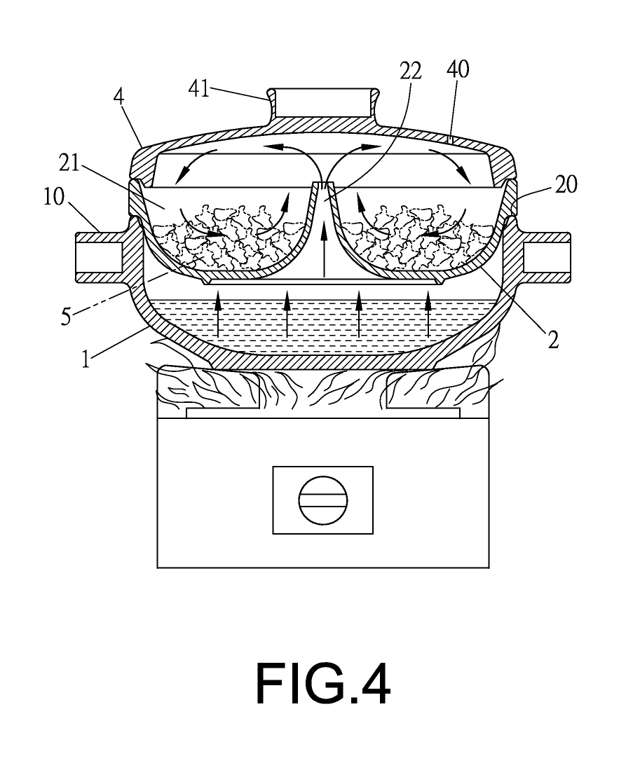

When using the bowl 2 and the steamer 3 to steam food, water is filled in the base 1. The food 5 is put on the board 31 in the steamer 3 and in the space 21 of the bowl 2. The bowl 2 is put in the base 1 and the steamer 3 is overlapped on the bowl 2. The underside of the steamer 3 rested on the top edge of the bowl 2, and the lip 30 of the steamer 3 contacts the inside of the space 21. Therefore, the steamer 3 is positioned on the bowl 2. The cover 4 is then mounted to the steamer 3. The water is heated and becomes into steam which transfer heat to the food 5 via the bowl 2. The steam passes through the passage 22 and enters the room between the bowl 2 and the steamer 3. The steam circulates in the room between the bowl 2 and the steamer 3 to steam the food 5. Steam also passes through the apertures 32 of the board 31 to steam the food on the board 31. Because the board 31 is made by red soil which has better heat conduction feature so that the food 5 is evenly heated. The time required for steaming the food is shortened and the taste and flavor is maintained in the food 5. As shown in FIG. 4, the bowl 2 can be cooperated with the base 1 to steam food 5 without using the steamer 3. The bowl 2 is put in the base 1 and the cover 4 is mounted to the bowl 2. The juice of the food 5 is kept in the bowl 2 and the bowl 2 can be served as a bowl directly.

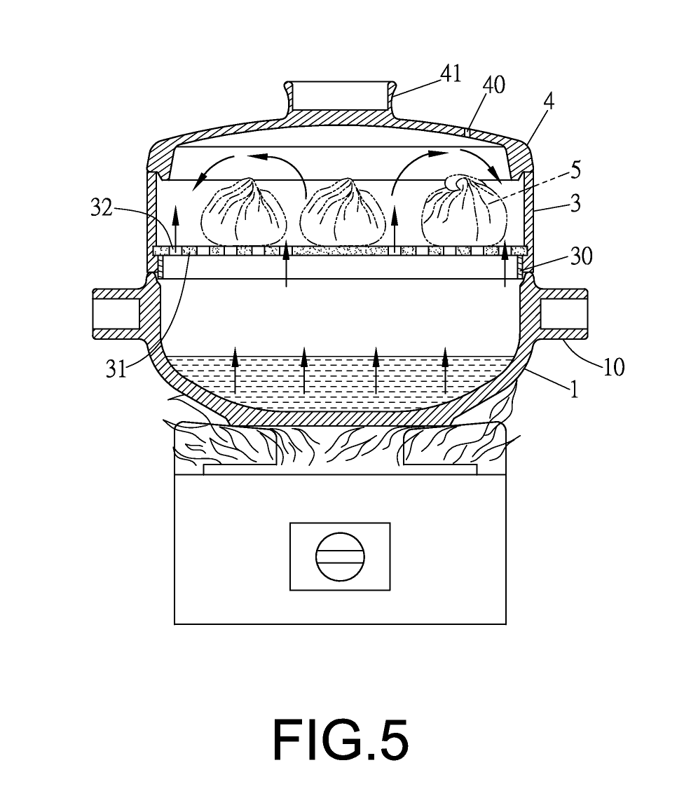

As shown in FIG. 5, the steamer 3 can be individually used to steam the food 5, and the cover 4 is mounted to the steamer 3. The steamer 3 is mounted on the base 1 and the food 5 is put on the board 31 without using the piece of fabric. The board 31 is made by red soil which absorbs moisture and is air permeable so that no moisture is trapped at the underside of the food 5 and the food 5 is not adhered on the board 31. Therefore, when picking the food 5 from the board 31, the underside of the food 5 is not torn apart and the juice is maintained in the food 5.

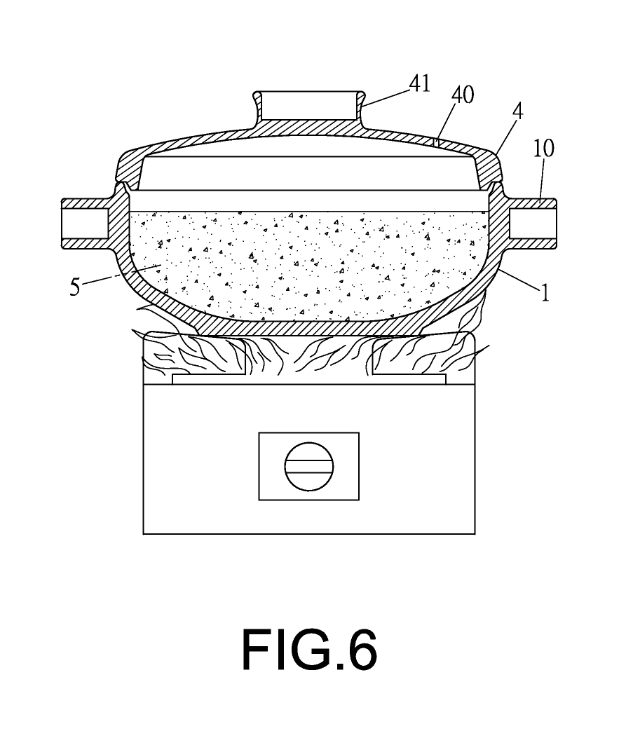

The base 1 can be directly used to cook food 5, the food 5 is directly put in the base 1 and the cover 4 is mounted to the base 1. The base 1 can be used to cook food 5 by way braising and boiling as shown in FIG. 6. The bowl 2 and the steamer 3 are optionally used with the base 1, so that the steamer assembly provides different ways of cooking.

While we have shown and described the embodiment in accordance with the present invention, it should be clear to those skilled in the art that further embodiments may be made without departing from the scope of the present invention.

What is claimed is:

1. A steamer assembly comprising:
a base made by fireproof ceramic and a handle extending from outside of the base;
a bowl put in the base and made by stoneware, a flange extending outward from an outside of the bowl, a space defined in the bowl and a protrusion extending from an inner end of the space, a passage defined through the protrusion;
a steamer mounted on the base or the bowl, the steamer being made by bamboo and having a lip extending from an underside thereof, a board being put in the steamer and made by red soil, multiple apertures defined through the board, and
a cover mounted to the base, the bowl or the steamer, the cover being made by fireproof ceramic and having multiple release holes defined therethrough, a lug extending centrally from a top of the cover.
